(19) United States
(12) Patent Application Publication
(10) Pub. No.: US 2026/0048328 A1
(43) Pub. Date: Feb. 19, 2026

(54) MULTI-FILE BASED GAME DEVELOPMENT ENVIRONMENT USING LARGE LANGUAGE MODELS

(71) Applicant: Sony Interactive Entertainment LLC, San Mateo, CA (US)

(72) Inventors: Joseph Logan Olson, San Mateo, CA (US); Kyungseo Cho, San Mateo, CA (US)

(21) Appl. No.: 18/802,596

(22) Filed: Aug. 13, 2024

(51) Int. Cl. A63F 13/60; G06F 40/20

(52) U.S. Cl. CPC A63F 13/60; G06F 40/20; A63F 2300/308; A63F 2300/6009

(57) ABSTRACT

One or more human users can collaborate with an LLM to create, read, and edit files for every step of computer game/software development, from initial brainstorming to a running web application. Advantageously collaboration is not limited to a single file or a single folder, but rather employs a full virtual file system that facilitates easy and intuitive collaboration across multiple files, provides a more traditional, recognizable code development experience, and affords ideation, building, testing, and deploying the applications within a single web-based environment.

### FIELD

The disclosure below relates to technically inventive, non-routine solutions that are necessarily rooted in computer technology and that produce concrete technical improvements. In particular, the disclosure below relates to multi-file based game development environments using large language models (LLM).

### BACKGROUND

As recognized herein, current LLM systems may be used to help a computer game developer develop a computer game by, for example, receiving an input instruction and generating a dialog or some other requested asset in response. As further understood herein, however, the human-LLM dialog typically is in a single file-type format such as a chat window, which can quickly become cumbersome and confusing.

To address this problem, present principles enable one or more human developers to collaborate with an LLM to create, read, and edit files for every step of computer game/software development, from initial brainstorming to a running web application. Advantageously, collaboration is not limited to a single file or a single folder, but rather employs a full virtual file system that facilitates easy and intuitive collaboration across multiple files, provides a more traditional, recognizable code development experience, and affords ideation, building, testing, and deploying the applications within a single web-based environment.

### SUMMARY

Accordingly, an apparatus includes at least one processor system configured to present on at least one display at least one user interface (UI) for collaborating with at least one large language model (LLM) to generate a computer simulation application. The UI includes, in a single view, a left panel, to the right of the left panel a center workspace panel, and to the right of the center workspace panel a right dialog panel. The left panel includes a file browser window configured to name and delete files. Below the file browser window is a view window configured to select a view from among plural views, with each view including a set of respective open files. Below the view window is a console output window providing test status and/or output from programs that are run.

The center workspace panel includes representations of plural virtual files that are open. The representations are free-floating panels that can be moved, resized, and closed. Each virtual file includes editable text representing a respective part of the application. The right chat panel to the right of the center workspace panel includes dialog between the LLM and a developer related to generating the application. The processor system is configured to execute the application to present a computer simulation on at least one video display.

In example embodiments the processor system can be configured to present in the right chat panel the dialog contemporaneously with generating and/or altering virtual files in the center workspace panel consistent with the dialog in the right chat panel.

In some embodiments each representation in the center workspace panel includes a respective history button selectable to present a history of edits to the respective virtual file and revert to an earlier version of the respective virtual file.

In non-limiting implementations the processor system can be configured to, responsive to a first one of the virtual files being a first file type, provide a preview button selectable to view text of the virtual file rendered as markdown.

In some non-limiting implementations the processor system can be configured to, responsive to a first one of the virtual files being a second file type, provide a play button selectable to build and/or run the first one of the virtual files.

If desired, the processor system can be configured to present original content authored by the LLM in at least a first one of the representations of virtual files in a first appearance and present modified content authored by the LLM in the first one of the representations of virtual files in a second appearance different from the first appearance.

In example embodiments the processor system may be configured to receive from the LLM a first virtual file generated by the LLM responsive to developer input to combine at least portions of at least second and third virtual files generated by the LLM.

In certain examples, the processor system may be configured to, responsive to at least a first one of the virtual files comprising a test file, automatically execute a test responsive to new code being added to the test file and present results of the test.

In another aspect, a method includes inputting information related to a computer game application to at least one large language model (LLM). The method also includes enabling at least one game developer to collaborate with the LLM to create, read, and edit files for computer game development, from initial brainstorming to a running web application using a full virtual file system that facilitates collaboration across multiple files and affords ideation, building, testing, and deploying the application within a single web-based environment.

In another aspect, an apparatus includes at least one computer storage medium that is not a transitory signal and that in turn includes instructions executable by at least one processor system to present on at least one display a dialog between at least one developer of a computer game application and a large language model (LLM), and while presenting the dialog, present on the display plural virtual files written by the LLM responsive to the dialog.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 illustrates example overall logic in example flow chart format;

FIG. 3 illustrates an example user interface (UI);

FIG. 4 illustrates an example virtual file representation showing history;

FIG. 5 illustrates an example virtual file representation with “play” selected;

FIG. 6 illustrates an example virtual file representation with “preview” selected”

FIG. 7 illustrates an example virtual file representation showing LLM additions as a “diff” (appearing differently than the original LLM content);

FIG. 8 illustrates just the center workspace panel and left dialog panel illustrating consolidating two related virtual files into one;

FIG. 9 illustrates just the center workspace panel and left dialog panel illustrating the LLM's system prompt;

FIGS. 10 and 11 illustrate example ancillary logic in example flow chart format; and

FIG. 12 illustrates a UI consistent with FIG. 11.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

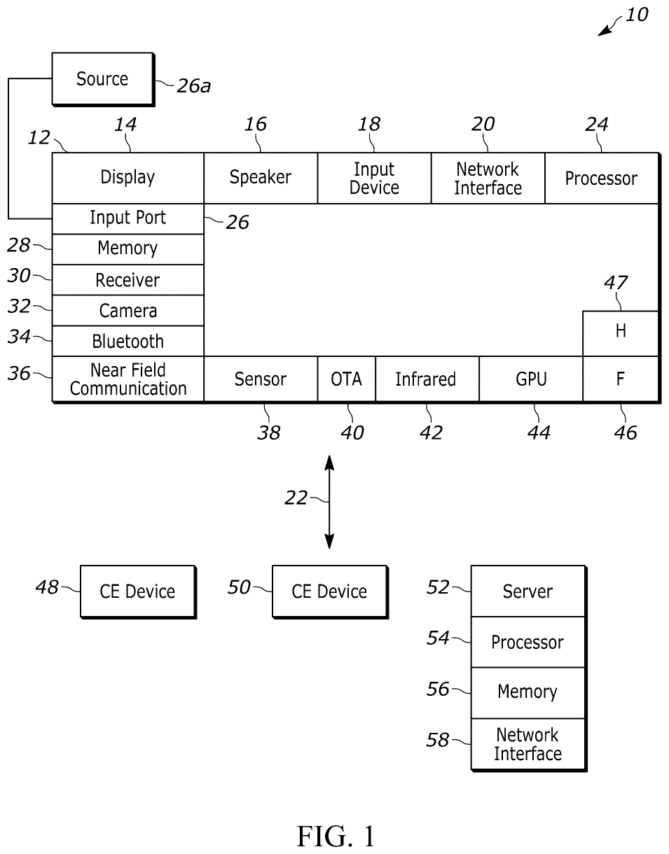

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command).

The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components discussed in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Large language models (LLM) such as a generative pre-trained transformer (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

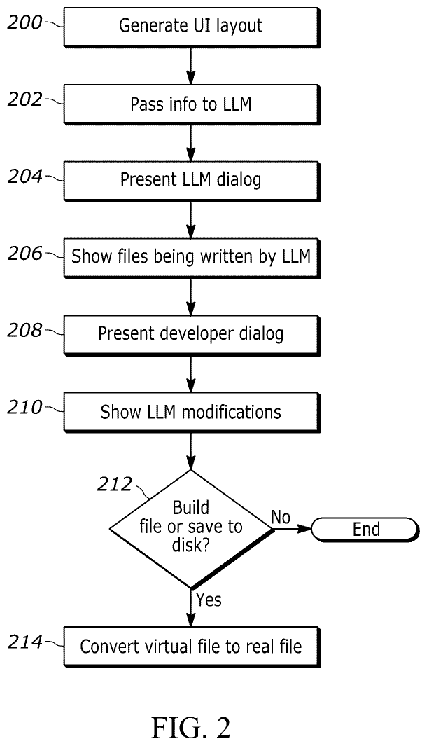

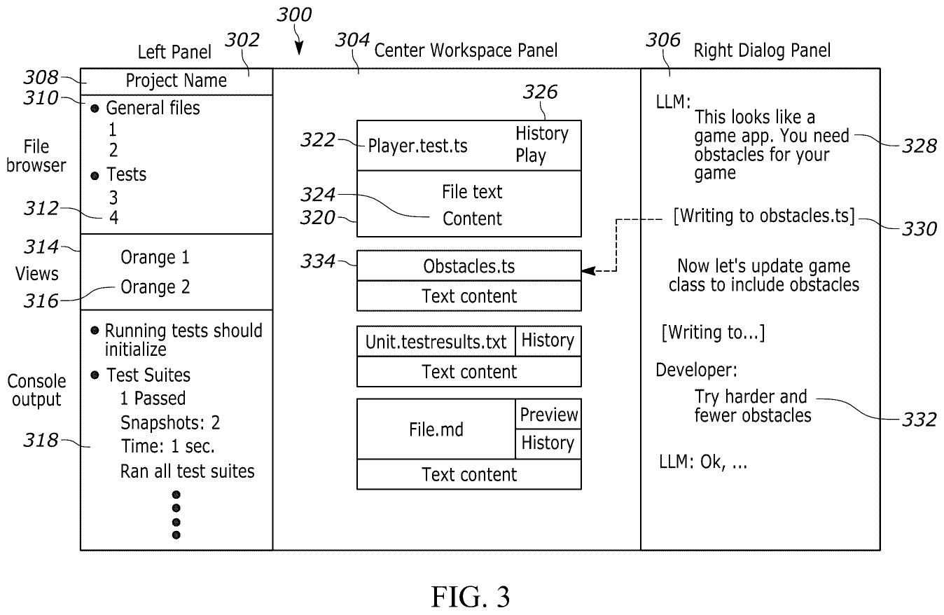

FIG. 2 illustrates overall example logic. Commencing at state 200, a UI layout is generated. An example UI layout is shown in FIG. 3 and discussed in detail herein.

Moving to state 202, information is passed to an LLM. The information may include initial files and/or comments concerning an application to be authored, such as a computer simulation application such as a computer game application.

Responsive dialog from the LLM is presented on a display at state 204. Examples of such dialog are provided herein. Along with the dialog of the LLM essentially stating what the LLM is doing, at state 206 files being written by the LLM in consonance with the dialog are presented on the display.

Moving to state 208, a human developer may input dialog to the LLM such as a query or command to modify something the LLM has done, and this developer dialog is presented on the display. Any ensuing LLM modifications to the files are presented at state 210.

The files contemplated thus far may be real files but typically are virtual files. State 212 indicates that when a virtual file is built out as a website or saved to disk, it is converted at state 214 to a real file.

FIG. 3 illustrates an example UI 300 consistent with present principles. The example UI 300 shown in FIG. 3 includes, in a single view, a left panel 302, to the right of the left panel a center workspace panel 304, and to the right of the center workspace panel a right dialog panel 306.

The left panel 302 can include a project name space 208 indicating the name of the project to which the UI 300 pertains. The left panel 302 also may include a file browser window 310 that is configured to name and delete files by filenames 312. As shown, the filenames 312 may be categorized such as into a general category, a test category, and so on.

Below the file browser window 310 is a view window 314 configured to select a view from among plural views 316. Each view includes a set of respective open files. Below the view window 314 is a console output window 318 providing test status and/or output from programs that are run. As shown, this may include indicating the number of tests run on a particular file, the number of passed tests, the number of failed tests, the time it took to run a test, and test notes.

The example center workspace panel 304 in FIG. 3 includes representations 320 of plural virtual files that are open. The representations 320 are free-floating panels that can be moved, resized, and closed using, e.g., a point-and-click device to drag and drop the panels. Each virtual file includes a file name 322 and editable text 324 representing a respective part of the application. Also, in the upper right portion of the title header, one or more buttons 326 may appear or be selected from a drop-down menu.

The example right chat panel 306 to the right of the center workspace panel 304 in FIG. 3 can include dialog, shown in text, between the LLM and a developer related to generating the application. In the example shown, an initial LLM comment 328 appears and is based on initial information sent to the LLM at state 202 in FIG. 2. When the LLM writes a virtual file, this is indicated by brackets 330, indicating the name of the virtual file being written. Developer comments 332 also appear directing the LLM to refine its output.

In the example shown, the dialog in the right chat panel 306 is presented contemporaneously with generating and/or altering virtual files in the center workspace panel 304 consistent with the dialog in the right chat panel. Thus, when the LLM indicates by brackets 330 that it is writing to a file called, for illustration, “obstacles.ts”, a representation 334 of “obstacles.ts” is presented in the center workspace window 304 as it is being written.

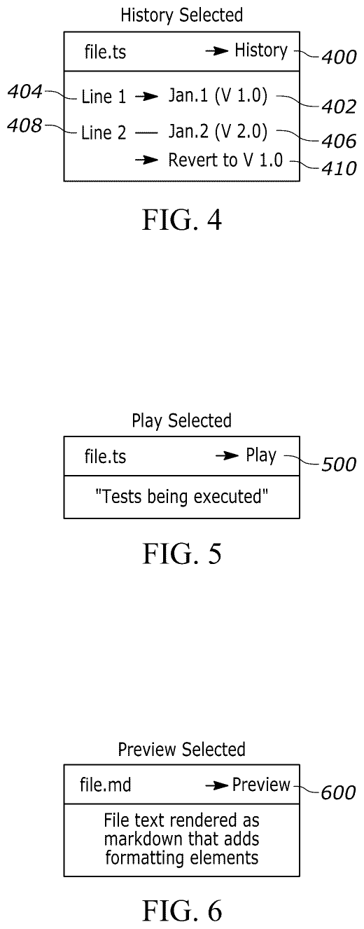

As mentioned above, one or more buttons 326 may be presented in each virtual file in the center workspace panel 304. As best shown in FIG. 4, one such button may be a history button 400 that is selectable to present a history of edits to the respective virtual file and revert to an earlier version of the respective virtual file. More particularly, when history is selected an indication 402 of when a first line or lines 404 of the file were created is presented as well as an indication 406 of when a first line or lines 408 of the file were created. The user can select a selector 410 to revert to the original version defined by the first line or lines 404, deleting the second line or lines 408.

FIG. 5 illustrates that another button 326 from FIG. 3 may include a play button 500 selectable to build and/or run the virtual file.

FIG. 6 illustrates that another button 326 from FIG. 3 may include a preview button 600 selectable to view text of the virtual file rendered as markdown. The preview button 600 may be presented only responsive to the file being of a particular type such as a .md file. Markdown presentation illustrates various formatting elements of the file.

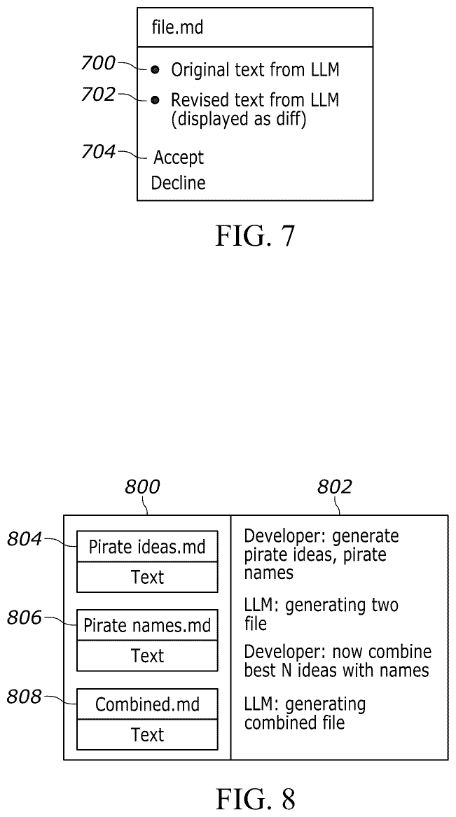

If desired, as shown in FIG. 7 original content 700 authored by the LLM can be presented in a representations of a virtual file in a first appearance and subsequently added or modified content 702 authored by the LLM can be presented in a second appearance to indicate a “diff”. For example, the modified content 702 may be highlighted or presented in a different color font than the original content 700. One or more selectors 704 may be provided to enable the developer to accept or reject the added content 702.

FIG. 8 illustrates an example workspace 800 next to an example dialog panel 802 indicating that the developer has given the LLM two tasks, resulting in the building of two virtual files by the LLM, in the example shown, pirate ideas 804 and pirate names 806. In response to the developer commanding the LLM to combine the top “N” ideas with corresponding names, the two files 804, 806 are consolidated by the LLM into a single file 808.

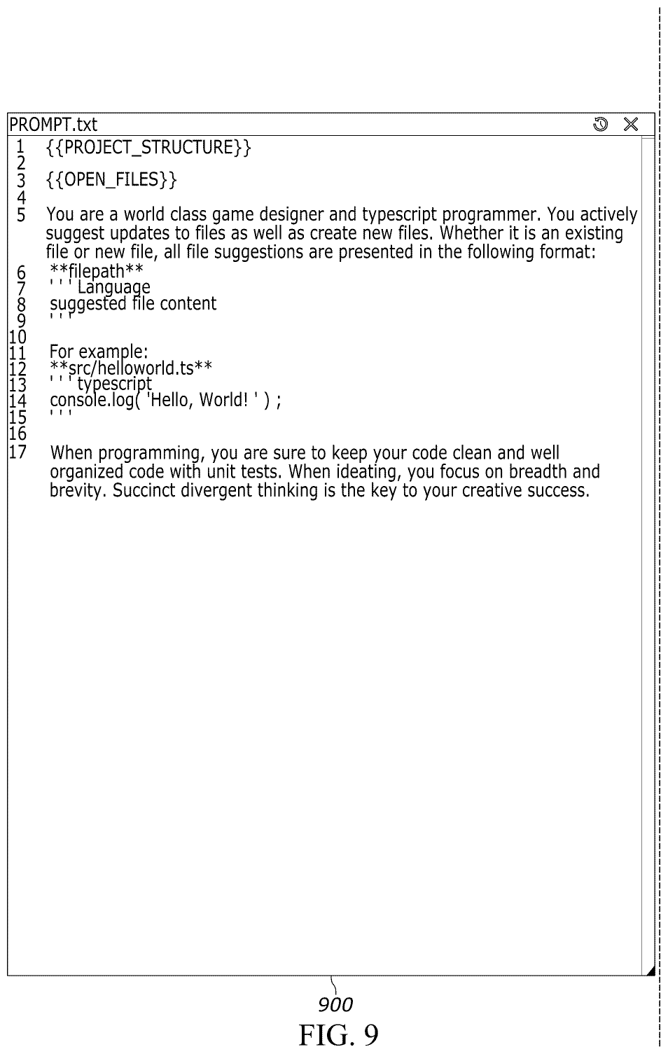

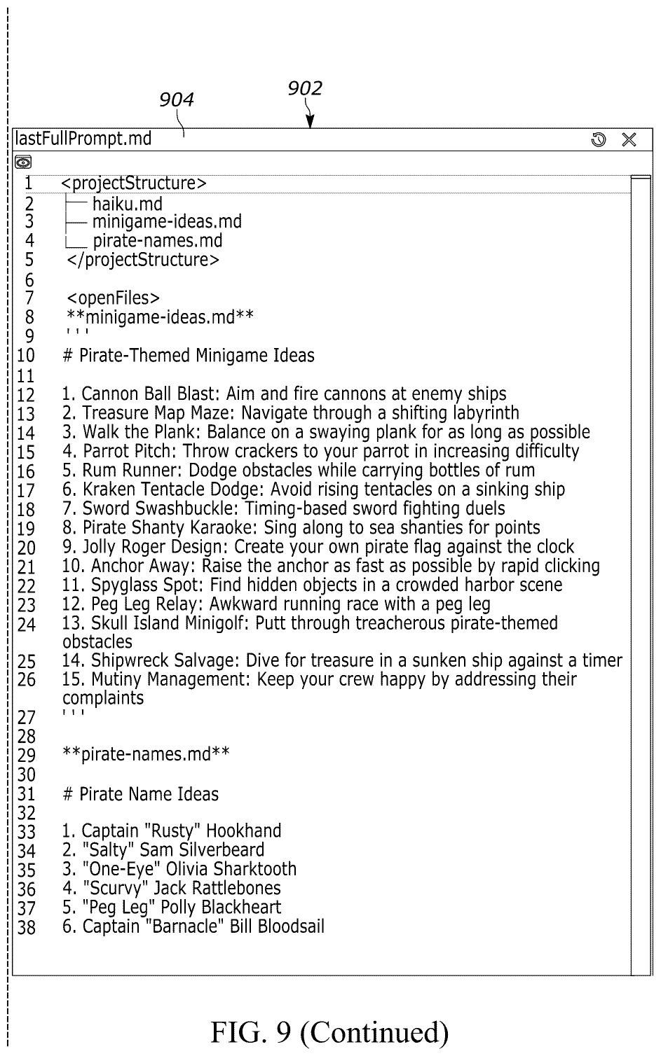

FIG. 9 illustrates an example workspace 900 next to an example dialog panel 902 illustrating a system prompt in file format that users can edit with a few pre-defined template strings to pass project information. Whenever the LLM runs, it also updates lastFullPrompt.md 904 so users can confirm their template strings are working correctly (note that PROJECT_STRUCTURE became a file tree in the example shown).

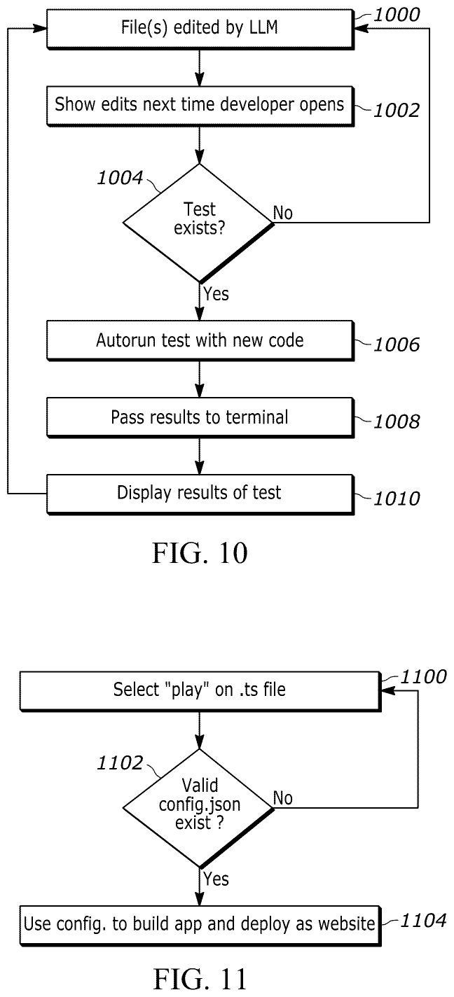

If a virtual file includes a test file, a test can be automatically executed responsive to new code being added to the test file, and results of the test presented. FIG. 10 illustrates.

Commencing at state 1000, a virtual file is edited by the LLM. Moving to state 1002, the edits are shown as they are made, and if the developer has exited prior to the LLM completing the edits the edits will appear next time the developer opens the appropriate workspace.

State 1004 indicates that if a test exists for the edited file, the tests are autorun with the new code at state 1006. The results are passed at state 1008 to the terminal and are displayed at state 1010 as a file unitTestResults.txt (which is visible to the LLM since it's a file).

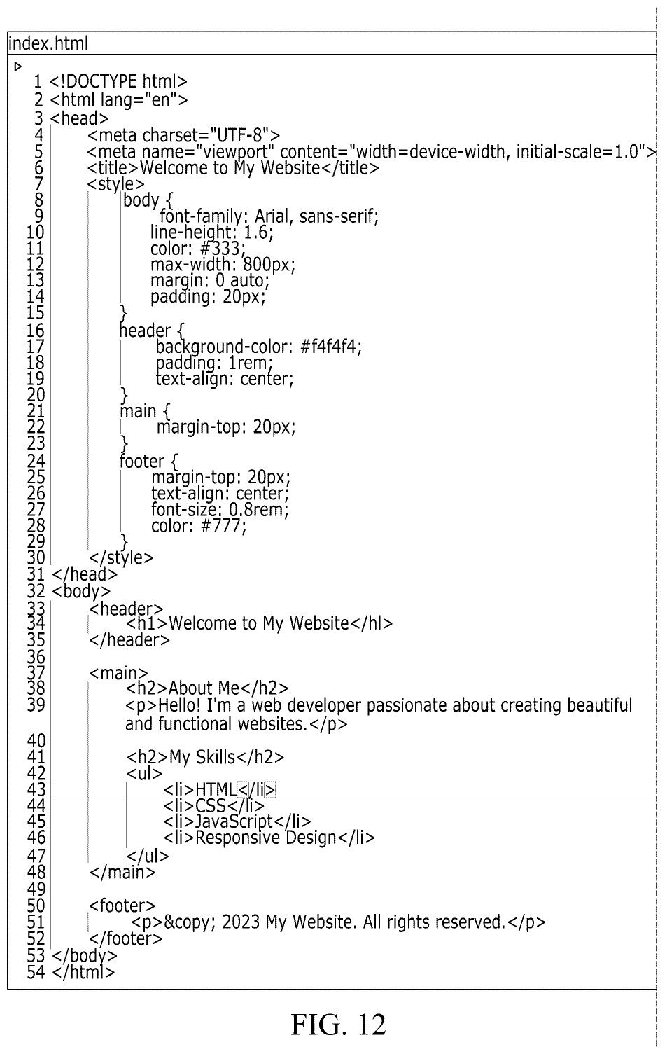

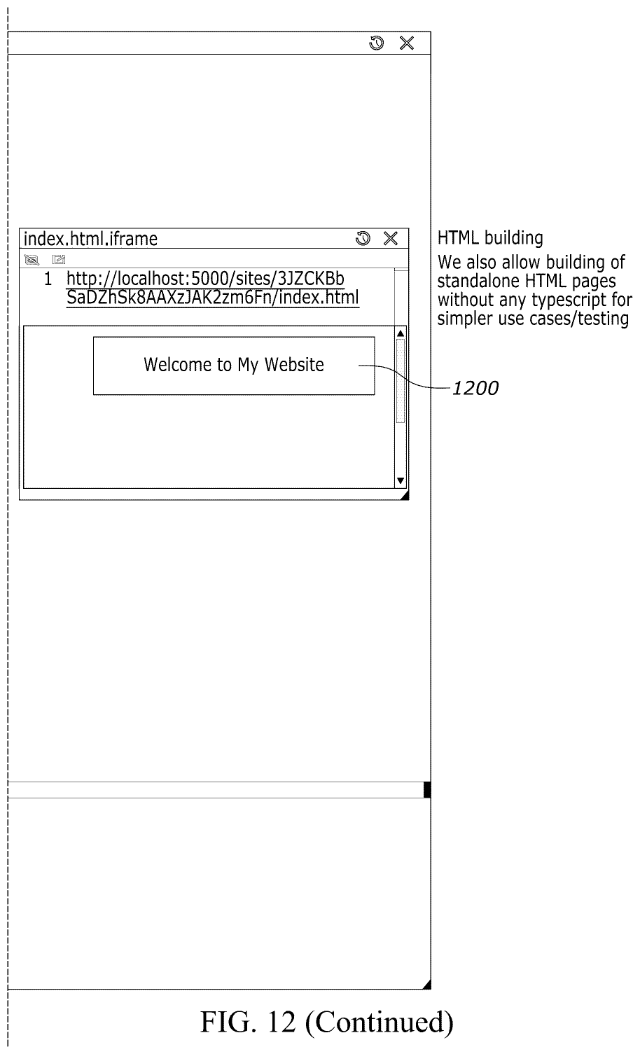

FIG. 11 details further operations resulting from selection of the play button 500 in FIG. 5 to build an application. Play is selected at state 1100 for, e.g., a .ts file and if it is determined at state 1102 that a valid config.json is in a folder, that config is used at state 1104 to build the application and deploy it as a website 1200 shown in FIG. 12. The website may also be placed in a file, e.g., in an “iframe” file that allows the developer to see the site without opening a second browser window.

Thus, present principles provide a software system for rapidly ideating and generating software using LLMs by focusing on files (plural) in a file system rather than ideate in a chat interface as if using Slack. Present principles use a chat interface only as a front-end to collaborate on files. Thus, while brainstorming with the LLM the resulting files can be viewed simultaneously and then generated/iterated on the necessary code files. The ability to run, test, build, and deploy code in the same environment is also provided so a designer can go end-to-end from ideation to experience a single user interface. Note that “deploy” means the software deploys an actual website another user can visit via URL and experience.

Present principles may employ a conflict-free replicated data type (CRDT) via a library called Automerge) which affords a google-docs style multi-user collaboration, file history, and file reconciliation. The LLM uses it when working on files, so a developer can make a request of the LLM and close the developer's window then come back to the site (on same or different computer) and the docs will be updated based on what the LLM did while the developer was gone.

Building a typescript webapp means creating all the files, running esbuild to turn the typescript into bundled javascript, and copying those files to a place the server serves sites from.

While the particular embodiments are herein shown and described in detail, it is to be understood that the subject matter which is encompassed by the present application is limited only by the claims.

What is claimed is:

1. An apparatus, comprising:
at least one processor system configured to:
present on at least one display at least one user interface (UI) for collaborating with at least one large language model (LLM) to generate a computer simulation application, the UI comprising, in a single view:
a left panel comprising a file browser window configured to name and delete files, below the file browser window a view window configured to select a view from among plural views, each view comprising a set of respective open files, and below the view window a console output window providing test status and/or output from programs that are run;
a center workspace panel to the right of the left panel and comprising representations of plural virtual files that are open, the representations being free-floating panels that can be moved, resized, and closed, each virtual file comprising editable text representing a respective part of the application; and
a right chat panel to the right of the center workspace panel and comprising dialog between the LLM and a developer related to generating the application; and
execute the application to present a computer simulation on at least one video display.

2. The apparatus of claim 1, wherein the processor system is configured to:
present in the right chat panel the dialog contemporaneously with generating and/or altering virtual files in the center workspace panel consistent with the dialog in the right chat panel.

3. The apparatus of claim 1, wherein each representation in the center workspace panel comprises a respective history button selectable to present a history of edits to the respective virtual file and revert to an earlier version of the respective virtual file.

4. The apparatus of claim 1, wherein the processor system is configured to:
responsive to a first one of the virtual files being a first file type, provide a preview button selectable to view text of the virtual file rendered as markdown.

5. The apparatus of claim 1, wherein the processor system is configured to:
responsive to a first one of the virtual files being a second file type, provide a play button selectable to build and/or run the first one of the virtual files.

6. The apparatus of claim 1, wherein the processor system is configured to:
present original content authored by the LLM in at least a first one of the representations of virtual files in a first appearance and present modified content authored by the LLM in the first one of the representations of virtual files in a second appearance different from the first appearance.

7. The apparatus of claim 1, wherein the processor system is configured to:
receive from the LLM a first virtual file generated by the LLM responsive to developer input to combine at least portions of at least second and third virtual files generated by the LLM.

8. The apparatus of claim 1, wherein the processor system is configured to:
responsive to at least a first one of the virtual files comprising a test file, automatically execute a test responsive to new code being added to the test file and present results of the test.

9. The apparatus of claim 1, comprising the display.

10. A method, comprising:
inputting information related to a computer game application to at least one large language model (LLM);
enabling at least one game developer to collaborate with the LLM to create, read, and edit files for computer game development, from initial brainstorming to a running web application using a full virtual file system that facilitates collaboration across multiple files and affords ideation, building, testing, and deploying the application within a single web-based environment.

11. The method of claim 10, comprising:
presenting on at least one display at least one user interface (UI) comprising:
a left panel comprising a file browser window configured to name and delete files, below the file browser window a view window configured to select a view from among plural views, each view comprising a set of respective open files, and below the view window a console output window providing test status and/or output from programs that are run;
a center workspace panel to the right of the left panel and comprising representations of plural virtual files that are open, the representations being free-floating panels that can be moved, resized, and closed, each virtual file comprising editable text representing a respective part of the application; and
a right chat panel to the right of the center workspace panel and comprising dialog between the LLM and a developer related to generating the application; and
execute the application to present a computer simulation on at least one video display.

12. The method of claim 11, comprising:
presenting in the right chat panel the dialog contemporaneously with generating and/or altering virtual files in the center workspace panel consistent with the dialog in the right chat panel.

13. The method of claim 11, wherein each representation in the center workspace panel comprises a respective history button selectable to present a history of edits to the respective virtual file and revert to an earlier version of the respective virtual file.

14. The method of claim 11, comprising:
responsive to a first one of the virtual files being a first file type, providing a preview button selectable to view text of the virtual file rendered as markdown.

15. The method of claim 11, comprising:
responsive to a first one of the virtual files being a second file type, providing a play button selectable to build and/or run the first one of the virtual files.

16. The method of claim 11, comprising:
presenting original content authored by the LLM in at least a first one of the representations of virtual files in a first appearance and presenting modified content authored by the LLM in the first one of the representations of virtual files in a second appearance different from the first appearance.

17. The method of claim 11, comprising:
receiving from the LLM a first virtual file generated by the LLM responsive to developer input to combine at least portions of at least second and third virtual files generated by the LLM.

18. The method of claim 11, comprising:
responsive to at least a first one of the virtual files comprising a test file, automatically executing a test responsive to new code being added to the test file and present results of the test.

19. An apparatus, comprising:
at least one computer storage medium that is not a transitory signal and that comprises instructions executable by at least one processor system to:
present on at least one display a dialog between at least one developer of a computer game application and a large language model (LLM); and
while presenting the dialog, present on the display plural virtual files written by the LLM responsive to the dialog.

20. The apparatus of claim 19, comprising the at least one processor.
